(19) United States
(12) Patent Application Publication
(10) Pub. No.: US 2013/0301253 A1
(43) Pub. Date: Nov. 14, 2013

(54) LIGHT TOWER AND METHOD

(71) Applicant: Paul Richard Drever, Fort McMurray (CA)

(72) Inventor: Paul Richard Drever, Fort McMurray (CA)

(21) Appl. No.: 13/943,689

(22) Filed: Jul. 16, 2013

(51) Int. Cl. F21L 4/02

(52) U.S. Cl. CPC F21L 4/02
USPC 362/184

(57) ABSTRACT

A light tower is disclosed comprising: a base with ground-engaging elements; a mast secured to the base; one or more lights mounted on the mast; a power source connected to the one or more lights; a heater connected to the power source; and a controller connected to cycle the power source and heater through one or more sequences according to a schedule, each sequence having an off mode, a pre-heat mode where the heater is on, and a lighting mode where the power source is on.

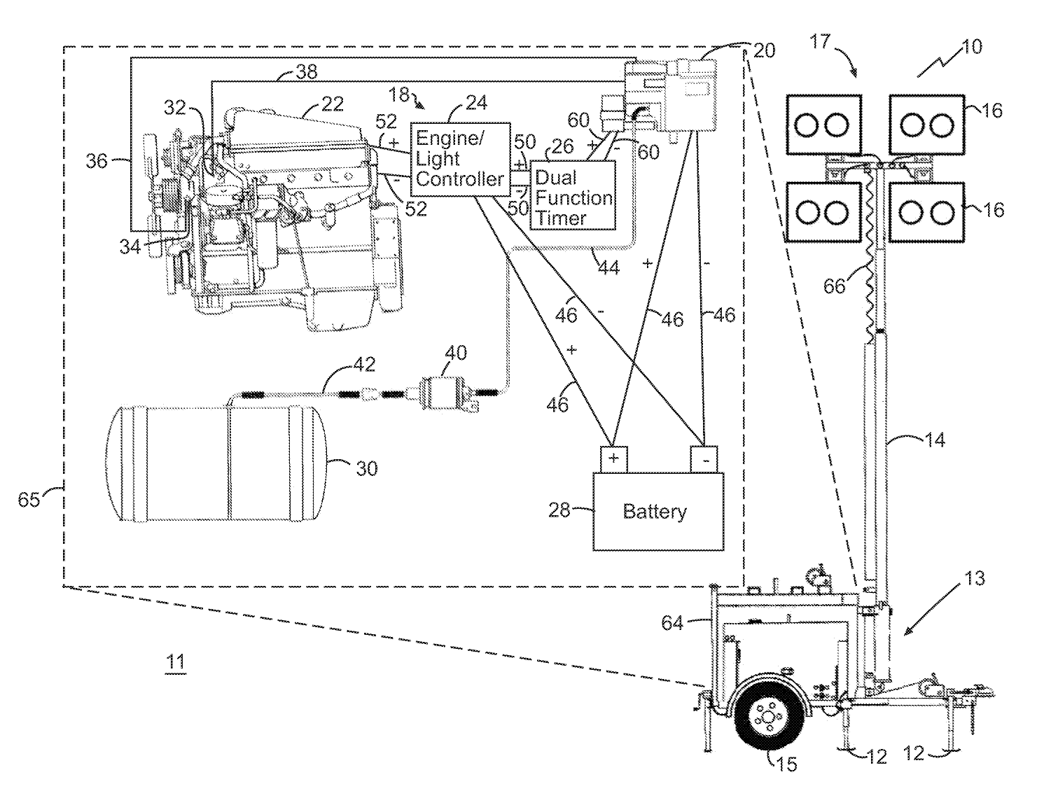

### TECHNICAL FIELD

This document relates to light towers and methods of operating light towers.

### BACKGROUND

The LSC100 is a light tower controller made by ALLMAND™ that turns the light tower on and off at predetermined times of day. In cold climates light towers have block heaters that can be manually plugged in to an external power source to allow the light tower to be started despite cold ambient temperatures.

### SUMMARY

A light tower is disclosed comprising: a base with ground-engaging elements; a mast secured to the base; one or more lights mounted on the mast; a power source connected to the one or more lights; a heater connected to the power source; and a controller connected to cycle the power source and heater through one or more sequences according to a schedule, each sequence having an off mode, a pre-heat mode where the heater is on, and a lighting mode where the power source is on.

A method is also disclosed of operating a light tower using a controller connected to the light tower, the method comprising: monitoring a time of day; at a first predetermined time, initiating a pre-heat mode where a heater supplies heat to a power source; at a second predetermined time, initiating a lighting mode where the power source supplies power to one or more lights mounted on the light tower; and at a third predetermined time, initiating a shut off mode where power to the one or more lights is shut off.

In various embodiments, there may be included any one or more of the following features: The power source is an engine. The engine has a liquid coolant circulation system, and the heater is connected to circulate and heat coolant through the liquid coolant circulation system. The heater is a diesel-fired heater. A battery is connected to the heater and controller. The heater, power source, and controller are within a compartment on the base. The controller further comprises one or more programmable timers. The one or more programmable timers comprise a dual-function timer for timing operation of the heater and power source. Each sequence is scheduled to be carried out over a twenty-four-hour period. The light tower is operated by cycling the power source and heater through one or more sequences. The light tower may be located in an environment with a low ambient temperature that can get at or below minus forty degrees Celsius. A combination of at least twenty of the light towers may be deployed at a work site.

These and other aspects of the device and method are set out in the claims, which are incorporated here by reference.

### BRIEF DESCRIPTION OF THE FIGURES

Embodiments will now be described with reference to the FIGURE, in which like reference characters denote like elements, by way of example, and in which:

The FIGURE is a side elevation view of a light tower, with dashed lines used to indicate a close up of the contents of the engine compartment of the light tower.

### DETAILED DESCRIPTION

Immaterial modifications may be made to the embodiments described here without departing from what is covered by the claims.

Light towers are used to permit work to be done in dark areas or during times of day such as night when light levels are low. Light towers are mobile units that can be conveniently towed and positioned where needed and provide a modular source of light to a work site. Safety requirements at oil industry and other work sites require good lighting at night. A single work site may operate a fleet of up to thousands of light towers in order to provide sufficient light for safe work conditions.

Light towers are often run during the winter months (from November to May) without being turned off. Such operation consumes excess fuel during day hours where the light tower is operating yet ambient light levels are bright enough to perform work without the light tower on. Work sites keep the light towers on during these months because it is uneconomical and inefficient to have a team of people manually turning the light towers on and off, and because even if the light towers could be turned off the engines of the light towers would freeze on cold days and be unable to be re-started when needed. For the latter reason the LSC100 is not believed to be in use in cold climates. Block heaters are supplied to pre-heat frozen engines, but since it is uneconomical to manually turn the light towers on and off in the first place it is even less economical to manually plug in and unplug a block heater for each light tower. In addition, it is not feasible to provide the necessary electricity sources for block heater operation on a work site, especially with work sites that are remote and off the electrical grid. Hence, work sites simply keep the fleet of light towers on all day and all night during the winter months.

Referring to the FIGURE, a light tower 10 is illustrated having a base 13, a mast 14, one or more lights 16, a power source such as an engine 22, a heater 20, and a controller 18. Base 13 has ground-engaging elements such as telescopic anchor posts 12 and wheels 15. Base 13 may be a mobile base with wheels 15 and thus capable of being towed by a truck. Mast 14 is secured to base 13, and may have a deployed (shown) and stowed position (not shown). Mast 14 may use one or more conventional methods for moving between the deployed and stowed position such as by telescopic extension and retraction of mast 14, and by rotation from the vertical position shown to a horizontal or angled stowed position (not shown). One or more lights 16 may be mounted on the mast 14, for example at or near a top end 17 of mast 14. Lights 16 may be metal halide lights, light emitting diodes (LEDs), or other suitable lights. Engine 22 is connected to lights 16 for example by appropriate wiring and circuitry 66.

Heater 20 may be a diesel or other type of fuel-fired heater. Heater 20 is connected to the engine 22, for example by connection to a liquid coolant circulation system, such as a built in radiator, of engine 22. To connect to the liquid coolant circulation system the heater 20 may employ coolant supply and return lines 38 and 36, respectively connected to the coolant supply and return ports 32 and 34 of engine 22. In the example shown, the heater 20 is connected to circulate and heat engine coolant through the liquid coolant circulation system. Such an arrangement permits a light tower that employs an engine 22 with a coolant system to be retrofitted with heater 20.

A fuel source 30 may be connected to pump fuel using fuel pump 40 to heater 20 through one or more fuel lines 42 and 44. Fuel source 30 may be the fuel source for the engine 22, so that heater 20 uses the existing fuel source as opposed to requiring an independent fuel source. Fuel received by heater 20 may be ignited or combusted by flame or flameless methods to heat and circulate engine coolant through engine 22. One or more coolant pumps (not shown) may be used to circulate coolant. Coolant used during winter months will be rated to remain in a liquid or flowable state at ambient temperatures so that heater 20 is able to circulate coolant through engine 22. In places like Fort McMurray, Alberta, coolant may be rated to minus sixty degrees Celsius. A heater 20 that is not fuel-fired may also be used, such as a block heater (not shown).

Controller 18 is connected to send control signals to engine 22 and heater 20 for example through control lines 52 and 60. Controller 18 will cycle the engine 22 and heater 20 through one or more sequences according to a schedule, such schedule being predetermined and in some cases directly programmable at the light tower 10 itself. Each sequence has at least an off mode, a pre-heat mode, and a lighting mode.

The controller 18 may operate by monitoring the time of day and initiating various events according to the preset schedule. Monitoring the time of day may be accomplished by various methods such as using a timer 26, which may be a dual-function timer 26 independently connected to an engine control unit 24 and heater 20. Timer 26 may be one or more programmable timers. A dual-function timer 26 may have one function for timing operation of the engine 22 and the other function for timing operation of the heater 20. The dual-function timer 26 permits retrofitting of an LSC100 controller by swapping the built-in timer with a dual-function timer 26 and a heater 20. Each sequence may be scheduled to be carried out over a twenty-four-hour period. Other monitoring methods include using a sensor such as a photocell (not shown) to monitor light levels and respond accordingly. Instead of a dual-function timer, two or more timers may be used.

An exemplary sequence may begin with both the heater 20 and engine 22 turned off or otherwise not operational. When the controller 18 detects a first predetermined time, such as half past three o'clock in the afternoon, the pre-heat mode may be initiated by, for example, the controller 18, in this case timer 26, sending a signal to heater 20 through control lines 60. Once heater 20 is activated, heater 20 begins to supply heat to engine 22 for example by circulating heated coolant through lines 36 and 38. In some cases the schedule may be programmed for a single day or plural days, for example if a thirty one day programmable timer is used.

The controller 18 continues to monitor the time, and at a second predetermined time, such as four o'clock in the afternoon of the same day or after a sufficient pre-heat period has elapsed, a lighting mode is initiated by, for example, the controller 18, in this case timer 26, sending a signal to engine controller 24 through lines 50, and controller 24 then sending signals to engine 22 through lines 52. When the lighting mode is initiated, the engine 22 turns on and supplies power to the one or more lights 16. During the lighting mode the heater 20 may be shut off if not needed, for example, on initiation of the lighting mode or after a suitable predetermined time interval after initiation of the lighting mode. Engine 22 may act as a generator converting fuel energy into electricity and sending the electricity to lights 16 via circuitry 66. Controller 24 may modulate and otherwise maintain operation of engine 22 as needed to operate lights 16.

Finally, when controller 18 detects a third predetermined time, such as half past eight o'clock in the morning the next day, controller 18 initiates the shut off mode, for example by timer 26 sending a signal to engine controller 24 through lines 50, and controller 24 sending a signal to engine 22 through lines 52. The light tower 10 may then enter a rest state where in some cases only timer 26 is operating and where lights 16 are off. In environments like work site 11 with an ambient temperature at or below minus forty degrees Celsius, engine 22 of light tower 10 will be hot enough to properly and safely restart before each lighting mode is initiated.

The light tower 10 may be cycled through the same or a modified sequence the next day. In some cases the light tower 10 may be cycled through two or more of the sequences in a twenty-four-hour period.

A battery 28 may be connected to one or more system components such as controller 18 and heater 20, using lines 46. Battery 28 may be used to provide ongoing power to controller 18 and heater 20, or may be used at least to provide the power required to start up controller 18 and heater 20.

The heater 20, engine 22, and controller 18 may be mounted within an engine compartment 64 in base 13. In the FIGURE dashed lines 65 illustrate that other components may be present in compartment 64. By providing all components within compartment 64 or otherwise connected to or part of light tower 10, no external parts or connections may be needed to operate light tower 10.

The schedule followed by controller 18 may be programmed by direct access to controller 18 by a worker or remotely through one or more networks (not shown), such as a radio network or internet.

A fleet, for example twenty or more, of the light towers disclosed in this document may be deployed at work site 11 at once. In some cases the only worker intervention that may be necessary for operation of the fleet may involve topping up fuel supplies and performing the initial programming of controller 18.

Although a fuel-based combustion engine 22 is used as a power source in the example shown, other power sources may be used such as an electric engine or fuel cell. When a component is described as being off, it should be understood that some base level of activity may still be occurring within the component. Exemplary heaters 20 include the TSL 17 made by WEBASTO™. Exemplary timers include a thirty one day programmable timer made by PROHEAT™. Other makes and models may be used. The light tower 10 may incorporate other components not discussed for example a ballast system for weighing down the light tower 10 in high winds. The light tower 10 may have a mode where the light tower 10 can be manually started and stopped as needed outside of the normal operating period under the schedule.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A light tower comprising:
a base with ground-engaging elements;
a mast secured to the base;
one or more lights mounted on the mast;
a power source connected to the one or more lights;
a heater connected to the power source; and
a controller connected to cycle the power source and heater through one or more sequences according to a schedule, each sequence having an off mode, a pre-heat mode where the heater is on, and a lighting mode where the power source is on.

2. The light tower of claim 1 in which the power source is an engine.

3. The light tower of claim 2 in which the engine has a liquid coolant circulation system, and the heater is connected to circulate and heat coolant through the liquid coolant circulation system.

4. The light tower of claim 3 in which the heater is a diesel-fired heater.

5. The light tower of claim 1 further comprising a battery connected to the heater and controller.

6. The light tower of claim 1 in which the heater, power source, and controller are within a compartment on the base.

7. The light tower of claim 1 in which the controller further comprises one or more programmable timers.

8. The light tower of claim 7 in which the one or more programmable timers comprise a dual-function timer for timing operation of the heater and power source.

9. The light tower of claim 1 in which each sequence is scheduled to be carried out over a twenty-four-hour period.

10. A method of operating the light tower of claim 1 by cycling the power source and heater through one or more sequences.

11. The method of claim 10 carried out while the light tower is located in an environment with an ambient temperature of or below minus forty degrees Celsius.

12. A combination of at least twenty of the light towers of claim 1 deployed at a work site.

13. A method of operating a light tower using a controller connected to the light tower, the method comprising:
monitoring a time of day;
at a first predetermined time, initiating a pre-heat mode where a heater supplies heat to a power source;
at a second predetermined time, initiating a lighting mode where the power source supplies power to one or more lights mounted on the light tower; and
at a third predetermined time, initiating a shut off mode where power to the one or more lights is shut off.
